(19) United States
(12) Patent Application Publication
(10) Pub. No.: US 2024/0075477 A1
(43) Pub. Date: Mar. 7, 2024

(54) NOZZLE, CARRIER, NOZZLE ASSEMBLY, AND SAMPLE PROCESSOR

(71) Applicants: BECKMAN COULTER BIOTECHNOLOGY (SUZHOU) CO., LTD., Suzhou, Jiangsu (CN); BECKMAN COULTER, INC., Brea, CA (US)

(72) Inventors: Wei SHI, Suzhou, Jiangsu (CN); Jingzhang WU, Suzhou, Jiangsu (CN); Erwin SCHOLZ, Brea, CA (US)

(73) Assignees: BECKMAN COULTER BIOTECHNOLOGY (SUZHOU) CO., LTD., Suzhou, Jiangsu (CN); BECKMAN COULTER, INC., Brea, CA (US)

(21) Appl. No.: 18/262,559

(22) PCT Filed: Jan. 24, 2022
(86) PCT No.: PCT/CN2022/073351

§ 371 Date: Jul. 21, 2023

(30) Foreign Application Priority Data
Jan. 22, 2021 (CN) 202110089276.1

(51) Int. Cl. B01L 3/00; B05B 15/60

(52) U.S. Cl. CPC B01L 3/56; B05B 15/60; B01L 2200/025; B01L 2200/0689; B01L 2300/0609

(57) ABSTRACT

The present disclosure relates to a nozzle for a sample processor, a carrier of a nozzle for a sample processor, a nozzle assembly for a sample processor, and a sample processor. The nozzle includes a body and an orifice. The body is adapted to be loaded and held in the carrier. The carrier can be slidably inserted into the sample processor in a detachable manner. The orifice is provided in the body and is configured to inject a sample from an injector body in a predetermined mode. An end surface of the body is adapted to abut against an end surface of the injector body along a sample injection direction. The nozzle assembly and the sample processor according to the present disclosure include the above-described nozzle and carrier. With the aid of the carrier, it is not necessary to install the nozzle to the injector body upstream of the nozzle, so that various adjustment operations when reinstalling the nozzle can be omitted, thereby simplifying the process of reinstalling the nozzle.

### TECHNICAL FIELD

The present disclosure relates to a nozzle for a sample processor and a sample processor including the nozzle, e.g., a flow cell sorter or an analyzer.

### BACKGROUND

The content in this section only provides background information related to the present disclosure, and does not necessarily constitute the prior art.

A sample processor is often used to detect, analyze, and/or sort samples such as microsomes or cells. The sample processor includes a fluid system, a nozzle system, and a sample processing system. The nozzle system includes an injector body in which a sheath fluid and a sample e.g., supplied by the fluid system are gathered and a nozzle for injecting the sample in the injector body in, e.g., a single-row arrangement manner. The sample is processed (e.g., detected, analyzed, and/or sorted) by the sample processing system while or after flowing through the nozzle system.

The nozzle usually has an orifice of 50 to 200 μm depending on the size of the sample. During the operation of the sample processor, the orifice of the nozzle is often blocked by the sample. At this moment, the nozzle needs to be disassembled, cleaned, or replaced. However, in some existing sample processors, the nozzle and the injector body are molded together, so the entire nozzle system needs to be removed before the nozzle can be cleaned or replaced. In some existing sample processors, the nozzle is fitted in the injector body in, e.g., a threaded manner. After the nozzle is reinstalled or replaced, there is still a large positional deviation, which will affect the result of sample processing.

Therefore, after reinstalling or replacing the entire nozzle system or nozzle, its peripheral devices (e.g., optical devices, electronic devices, or mechanical devices) need to be adjusted, e.g., to re-stabilize (e.g., debubble) the fluid, and to realign an optical path. In this way, the disassembly and reassembly of a nozzle assembly will be very complicated and time-consuming. In addition, when reinstalling or replacing the entire nozzle system or nozzle, it is easy to cause contamination risks.

Therefore, it is desirable in the art to provide a sample processor including a nozzle convenient to disassemble, clean, and assemble.

### SUMMARY OF THE INVENTION

This section provides a general summary of the present disclosure, rather than a comprehensive disclosure of a full scope of the present disclosure or all features of the present disclosure.

An objective of the present disclosure is to provide a nozzle for a sample processor, which can be disassembled and assembled independently of an injector body.

Another objective of the present disclosure is to provide an auxiliary device that facilitates the disassembly and assembly of a nozzle, e.g., a carrier for carrying the nozzle, a positioning member for positioning the nozzle, a supporting member for supporting the nozzle and biasing the nozzle toward the injector body, etc.

Yet another objective of the present disclosure is to provide a sample processor, including a nozzle convenient to disassemble, clean, and assemble.

According to an aspect of the present disclosure, a nozzle for a sample processor is provided. The nozzle includes a body and an orifice. The body is adapted to be loaded and held in the carrier. The carrier can be slidably inserted into the sample processor in a detachable manner. The orifice is provided in an end surface of the body and is configured to inject a sample from an injector body in a predetermined mode. The end surface of the body is adapted to abut against an end surface of the injector body along a sample injection direction.

According to the nozzle of the present disclosure, with the aid of the carrier, it is not necessary to install the nozzle to the injector body (e.g., transparent tube) upstream of the nozzle, so that various adjustment operations when reinstalling the nozzle can be omitted, thereby simplifying the process of reinstalling the nozzle. The transparent tube upstream of the nozzle is a light-transmitting optical element. Since the nozzle of the present invention is connected end-to-end with the transparent tube, there is no need to make any modification to the transparent tube, so the cost can be significantly reduced. In addition, the nozzle according to the present disclosure abuts against the end surface of the injector body along the sample injection direction, so a central axis position of the injector body (e.g., transparent tube) will not deviate, and therefore adverse effects on optical path detection, etc. will not be caused.

In some examples according to the present disclosure, the body is configured to be loaded in the carrier in a detachable manner.

In some examples according to the present disclosure, recesses or tabs engaged with the carrier are provided at opposite positions on an outer peripheral surface of the body.

In some examples according to the present disclosure, the end surface of the body is provided with a groove for accommodating a sealing member around the orifice.

According to another aspect of the present disclosure, a carrier of a nozzle for a sample processor is provided. The carrier includes a base. The base is provided with an accommodating portion for accommodating the nozzle and configured to be inserted into the sample processor in an independently detachable manner so that an end surface of the nozzle abuts against an end surface of an injector body along a sample injection direction.

With the aid of the carrier of the present disclosure, it is not necessary to install the nozzle to the injector body (e.g., transparent tube) upstream of the nozzle, so that various adjustment operations when reinstalling the nozzle can be omitted, thereby simplifying the process of reinstalling the nozzle. In addition, according to the carrier of the present disclosure, the nozzle abuts against the end surface of the injector body along the sample injection direction, so the nozzle will not deviate a central axis position of the injector body (e.g., transparent tube), and therefore will not adversely affect optical path detection, etc.

In some examples according to the present disclosure, the accommodating portion includes an elongated through hole, and the elongated through hole includes a large-sized portion for loading the nozzle and a small-sized portion for holding the nozzle.

In some examples according to the present disclosure, the carrier further includes: a sliding member capable of sliding relative to the base; and a biasing member biasing the sliding member toward the small-sized portion.

In some examples according to the present disclosure, an end surface of the sliding member has a shape matching an outer peripheral surface of the nozzle.

In some examples according to the present disclosure, the sliding member has an end that tapers toward the end surface to be engaged with a V-shaped slot of a positioning member of the sample processor.

In some examples according to the present disclosure, the carrier further includes notches provided on opposite side edges of the base, and the notches are configured to receive projections of the positioning member when the carrier is inserted in place.

In some examples according to the present disclosure, inclined surfaces extending from the notches toward an insertion end are provided on an upper surface of the base, and the inclined surfaces are adapted to guide the projections of the positioning member to slide into the notches.

In some examples according to the present disclosure, the carrier further includes a cover configured to cover at least a part of the base.

In some examples according to the present disclosure, the carrier further includes a protrusion provided on a lower surface of the base and adjacent to the insertion end.

In some examples according to the present disclosure, the carrier further includes locked members locking the carrier when inserted in place.

According to yet another aspect of the present disclosure, a nozzle assembly for a sample processor is provided. The nozzle assembly includes the above-described nozzle and/or carrier.

The nozzle assembly may include the above-described nozzle and carrier. That is, the nozzle assembly may include various features of the above-described nozzle and carrier and can bring similar technical effects.

According to a further aspect of the present disclosure, a sample processor is provided. The sample processor includes: a frame; an injector body configured to receive a sample and a sheath fluid and be fixed to the frame; a nozzle located at the outlet of the injector body and having an orifice for injecting the sample in the injector body in a predetermined mode; and a carrier adapted to load and hold the nozzle and configured to be slidably inserted into the frame in a detachable manner.

The nozzle assembly and the sample processor may include the above-described nozzle and carrier, that is, may include various features of the above-described nozzle and carrier, and can bring similar technical effects.

In some examples according to the present disclosure, the sample processor further includes a positioning member for positioning the nozzle, the positioning member is fixed to the frame and has a V-shaped slot, and the bottom of the V-shaped slot has a shape matching an outer periphery of the nozzle. The sample processor further includes a sliding member. The sliding member has an end that tapers toward the end surface to be engaged with the V-shaped slot of the positioning member.

In some examples according to the present disclosure, the nozzle is cylindrical, and a curvature of the outer peripheral surface of the nozzle is greater than that of the bottom of the V-shaped slot and that of the end surface of the sliding member.

In some examples according to the present disclosure, one of surfaces of the positioning member and the base that face each other is provided with projections, and the other of the surfaces of the positioning member and the base that face each other is provided with notches for receiving the projections when the carrier is inserted in place.

In some examples according to the present disclosure, inclined surfaces are provided on one side of the notches, and the inclined surfaces are adapted to guide the projections to slide into the notches.

In some examples according to the present disclosure, the sample processor further includes a supporting member for supporting the base.

In some examples according to the present disclosure, the supporting member includes a fixed portion fixed to the frame and a movable portion movable relative to the fixed portion, and the base is supported by the movable portion when inserted in place. A biasing member is provided between the fixed portion and the movable portion, and the biasing member biases the movable portion toward the nozzle.

In some examples according to the present disclosure, the movable portion includes a middle flat surface for supporting the base and downwardly inclined surfaces located on opposite sides of the middle flat surface in an insertion direction of the base. The base is provided with a protrusion adjacent to the insertion end on the surface facing the supporting member. The downwardly inclined surfaces are adapted to guide the sliding of the protrusion.

In some examples according to the present disclosure, a protrusion height of the protrusion is greater than or equal to the height of a corresponding part of the nozzle protruding from the carrier when the nozzle is loaded into the carrier.

In some examples according to the present disclosure, the sample processor further includes locking members capable of moving between a locking position and an unlocking position. The carrier includes locked members. The locking members are configured to prevent the locked members from moving at the locking position and allow the locked members to move at the unlocking position.

In some examples according to the present disclosure, the locking members are rotatably installed to the frame via pivots, and the locked members are pins.

### DESCRIPTION OF THE DRAWINGS

Through the following description with reference to the accompanying drawings, the features and advantages of one or more embodiments of the present disclosure will be more easily understood. In the accompanying drawings:

FIG. 1 is a schematic longitudinal section view of a sample processor according to an embodiment of the present disclosure;

FIGS. 2A to 2D are schematic views of an installation process of a nozzle assembly according to an embodiment of the present disclosure;

FIG. 3 is a perspective schematic view of a nozzle according to an embodiment of the present disclosure;

FIG. 4 is a schematic longitudinal sectional view of the nozzle of FIG. 3;

FIG. 5 is a perspective schematic top view of a carrier according to an embodiment of the present disclosure;

FIG. 6 is a schematic view of the carrier of FIG. 5 viewed from another direction;

FIG. 7 is a perspective schematic bottom view of a carrier according to an embodiment of the present disclosure;

FIG. 8 is a schematic view of the carrier of FIG. 7 viewed from another direction;

FIG. 9 is a schematic view of a carrier from which an upper cover is removed according to an embodiment of the present disclosure;

FIGS. 10A to 10E are schematic views showing a process of installing a nozzle on a carrier;

FIG. 11 is a perspective schematic top view of a positioning member according to an embodiment of the present disclosure;

FIG. 12 is a perspective schematic bottom view of a positioning member according to an embodiment of the present disclosure;

FIG. 13 is a schematic plan view showing the cooperation of a nozzle assembly with a positioning member when inserted in place;

FIGS. 14A to 14D are schematic views showing the mutual cooperation between a carrier and projections of a positioning member during an insertion process;

FIG. 15 is a perspective schematic view of a supporting member according to an embodiment of the present disclosure;

FIG. 16 is a schematic longitudinal sectional view of the supporting member of FIG. 15;

FIGS. 17A to 17D are schematic views showing the mutual cooperation between a carrier and a supporting member during an insertion process; and

FIG. 18 is a perspective schematic view of a frame according to an embodiment of the present disclosure.

### DETAILED DESCRIPTION

The present disclosure will be described in detail below through example embodiments with reference to the accompanying drawings. In the several drawings, similar reference numerals indicate similar parts and components. The following detailed description of the present disclosure is for illustrative purposes only, and is by no means limiting the present disclosure and applications or uses thereof. The embodiments described in this specification are not exhaustive, but are only some of a plurality of possible embodiments. The example embodiments may be implemented in many different forms, and should not be construed as limiting the scope of the present disclosure. In some example embodiments, well-known processes, well-known device structures, and well-known technologies may not be described in detail.

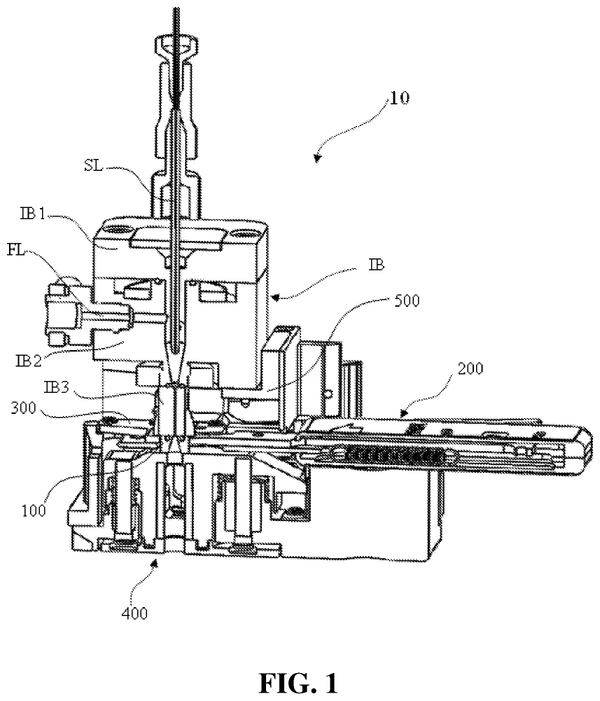

FIG. 1 is a schematic longitudinal section view of sample processor 10 according to an embodiment of the present disclosure. An overall structure of sample processor 10 will be described below with reference to FIG. 1.

As shown in FIG. 1, sample processor 10 includes an injector body IB, nozzle 100, carrier 200, positioning member 300, supporting member 400, and frame 500. Frame 500 serves as a fixed part of sample processor 10 and is used to support and install other parts. The injector body IB, positioning member 300, and supporting member 400 are directly or indirectly fixed to frame 500. Carrier 200 is used to carry nozzle 100 and may be inserted into sample processor 10 (frame 500) or disassembled from sample processor 10 (frame 500) with nozzle 100.

The various parts of sample processor 10 shown in FIG. 1 are assembled in place and in a working state. When sample processor 10 is operating, the injector body IB receives a sample from a sample line SL and a fluid such as a sheath fluid from a fluid line FL. The sample and the sheath fluid are gathered in the injector body IB, and then injected through nozzle 100. After the sample flows through the injector body IB and is injected from nozzle 100, the sample is detected, analyzed, or sorted.

The injector body IB generally includes: cover IB1 provided with a sample port coupled to the sample line SL; base IB2 provided with a fluid port coupled to the fluid line FL; and a transparent tube IB3 allowing light transmission for detection. Cover IB1 and transparent tube IB3 are respectively located on upper and lower sides of base IB2.

Nozzle 100 is located at the outlet of the injector body IB (transparent tube IB3). The sample is injected via the nozzle in, e.g., a single-row arrangement manner. According to a flow direction of the fluid and the sample, the injector body IB is an upstream part of nozzle 100. Therefore, the “injector body” referred to herein refers to a part upstream of the nozzle where the sample and the fluid such as the sheath fluid are gathered. It should be understood that the structure of the injector body may be changed as needed and is not limited to the specific example shown in FIG. 1.

Nozzle 100 abuts against a lower end surface of the injector body IB (transparent tube IB3) by means of carrier 200. Nozzle 100 and carrier 200 constitute a nozzle assembly of the present disclosure. Nozzle 100 is carried by carrier 200 instead of being fitted in the injector body IB (transparent tube IB3) as in the prior art. When carrier 200 is installed in place with the aid of positioning member 300 and supporting member 400, etc., nozzle 100 is automatically aligned with the outlet of the injector body IB (transparent tube IB3). Therefore, according to sample processor 10 of the present disclosure, the assembly and disassembly of nozzle 100 are completely independent of the injector body IB. After reinstalling or replacing nozzle 100, it is not necessary to adjust its peripheral devices (e.g., optical devices, electronic devices, or mechanical devices). For example, it is not necessary to re-stabilize (e.g., debubble) the fluid, and not necessary to realign an optical path. In this way, the disassembly and reassembly of nozzle 100 will be significantly simplified. Moreover, when carrier 200 is installed, it is not necessary to operate nozzle 100, so the risk of contamination can be avoided or reduced.

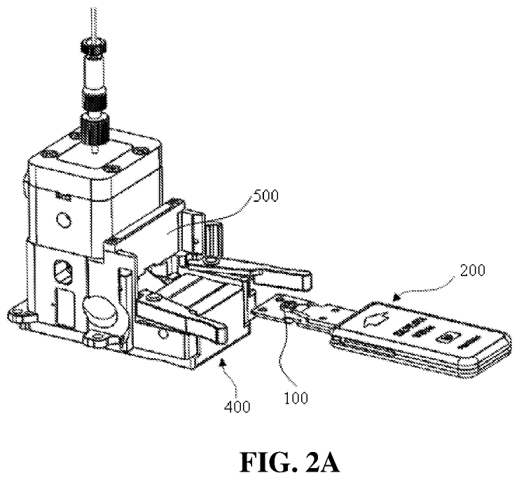

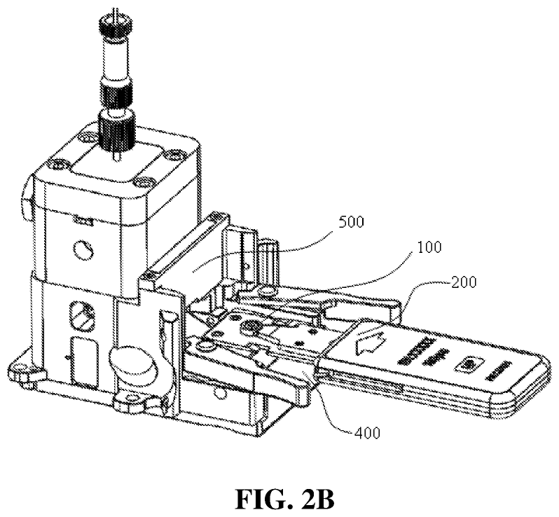

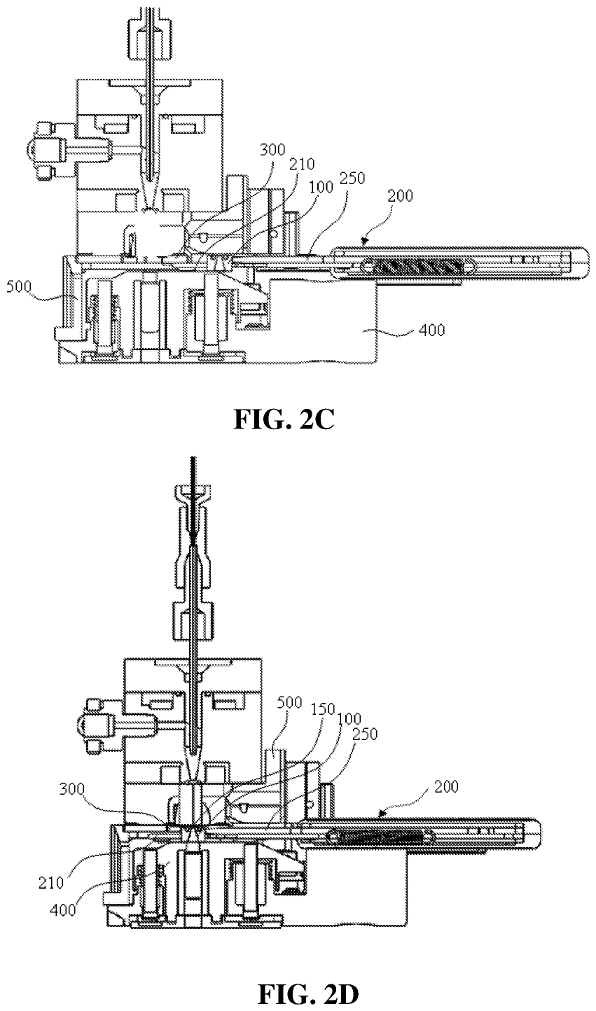

FIGS. 2A to 2D are schematic views of an installation process of a nozzle assembly according to an embodiment of the present disclosure. An assembly process of a nozzle assembly according to the present disclosure will be described below with reference to FIGS. 2A to 2D.

As shown in FIG. 2A, nozzle 100 has been loaded on carrier 200 to form a nozzle assembly, and the nozzle assembly is outside sample processor 10 and is in a state ready to be inserted. As shown in FIG. 2B, the nozzle assembly is placed on supporting member 400, and the nozzle assembly is inserted toward the inside of sample processor 10 under the guidance of supporting member 400. As shown in FIG. 2C, an insertion end of the nozzle assembly has been inserted between supporting member 400 and positioning member 300. As shown in FIG. 2D, an outer peripheral surface of nozzle 100 abuts against positioning member 300, whereby the nozzle assembly is inserted in place. At this moment, nozzle 100 is supported by supporting member 400 and abuts against a lower end surface of the injector body IB via sealing member 150. That is, nozzle 100 is restricted among carrier 200, positioning member 300, supporting member 400, and the injector body IB.

The various parts of sample processor 10 will be described in detail below.

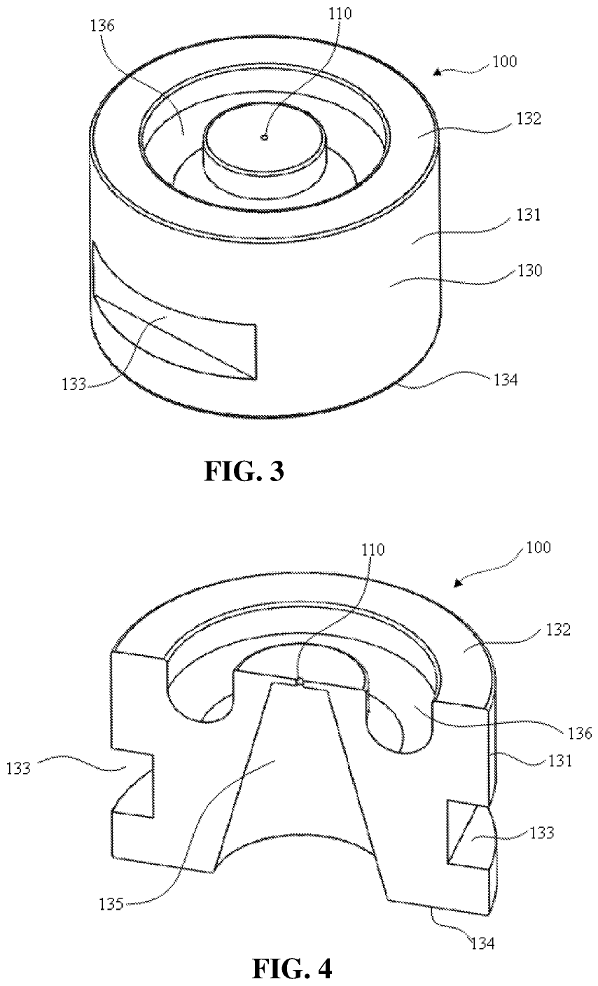

FIG. 3 is a perspective schematic view of nozzle 100 according to an embodiment of the present disclosure. FIG. 4 is a schematic longitudinal sectional view of nozzle 100 of FIG. 3. Nozzle 100 will be described below with reference to FIGS. 3 and 4.

As shown in FIGS. 3 and 4, nozzle 100 has body 130 that is generally cylindrical or button-shaped. Body 130 has tubular outer peripheral surface 131 and end surfaces 132 and 134 located at opposite ends of outer peripheral surface 131. It should be understood that the shape of the body is not limited to the specific example shown, and may be any other suitable shape adapted to be loaded on a carrier.

Orifice 110 is provided at approximately the center of end surface 132. Orifice 110 extends along an axial direction. Orifice 110 is configured to inject samples in, e.g., a single-row arrangement manner. The samples are, e.g., microsomes or cells. Therefore, the diameter of orifice 110 is approximately between 50 μm and 200 μm, usually between 70 μm and 100 μm. Regarding the diameter of orifice 110, the diameter of outer peripheral surface 131 of body 130 may be, e.g., 5.5 mm. An axial height of orifice 110 is generally between 75 μm and 125 μm. It can be seen that the size of orifice 110 is very small. Therefore, the precision requirements of sample processor 10 are very high, and the requirements for the assembly of the nozzle are also very high. It should be understood that the position and size of the orifice are not limited to the specific example shown, but may be changed as needed.

Hollow portion 135 that facilitates the passage of the sample may be provided between orifice 110 and end surface (a lower end surface in the figure) 134. Hollow portion 135 has a tapered shape in the illustrated example, or may have another suitable shape, e.g., a cylindrical shape.

Groove 136 for accommodating a sealing member may be provided on a radial outer side of orifice 110 on end surface (an upper end surface in the figure) 132 of body 130. Groove 136 has an annular shape surrounding orifice 110 to receive a sealing member such as an O-ring. When end surface 132 abuts against the injector body IB (transparent tube IB3), the seal between the nozzle and the injector body IB (transparent tube IB3) is achieved by the sealing member accommodated in groove 136. It should be understood that the sealing member and the groove for accommodating the sealing member may also be provided on the end surface of the injector body IB (transparent tube IB3), rather than having to be provided on the nozzle.

Recesses 133 are provided at opposite positions on outer peripheral surface 131 of body 130. Recesses 133 can be engaged with tabs or edges of carrier 200, thereby holding nozzle 100 on carrier 200. It should be understood that the feature of nozzle 100 engaged with carrier 200 is not limited to recesses 133 shown in the figure, and may be, e.g., tabs engaged with recesses of carrier 200.

It should be understood that the structure of nozzle 100 is not limited to the specific example shown in the figure, but may be changed as needed. Nozzle 100 may be integrally formed with carrier 200 in, e.g., a molding manner. In this case, recesses 133 may be omitted or may be changed. Alternatively, nozzle 100 may be loaded on carrier 200 in a detachable manner, as will be described in detail below.

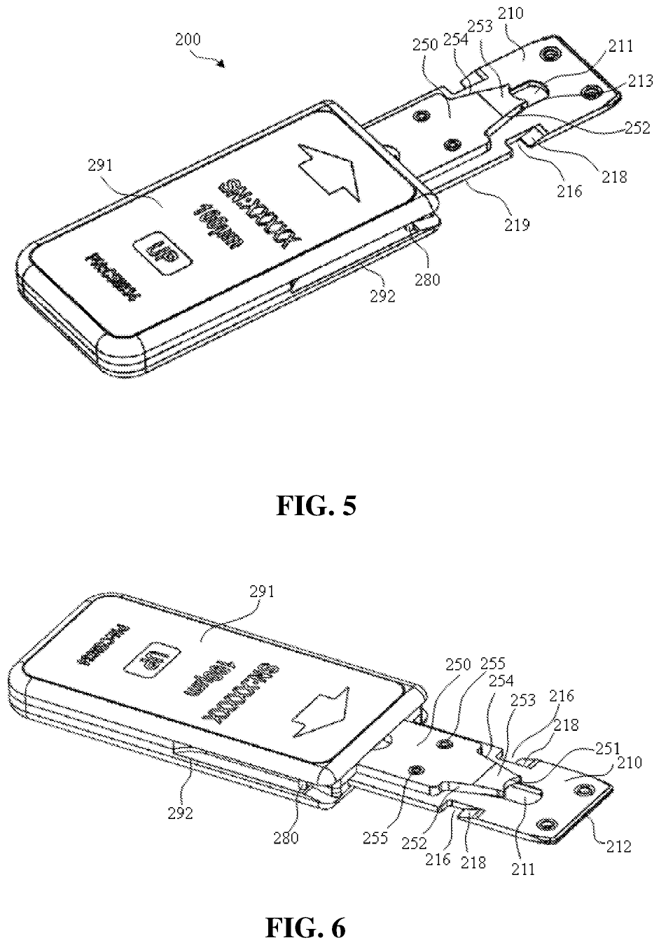

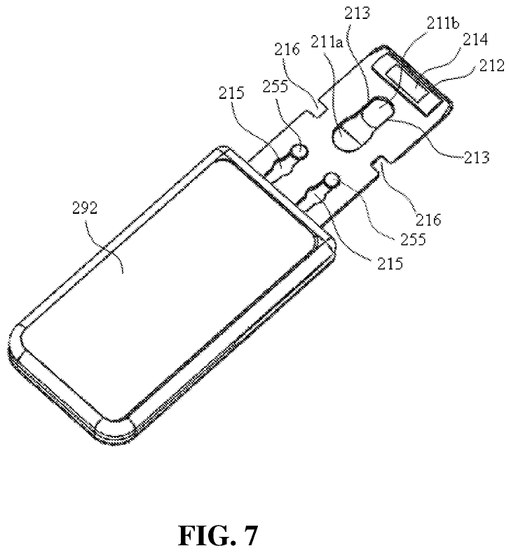

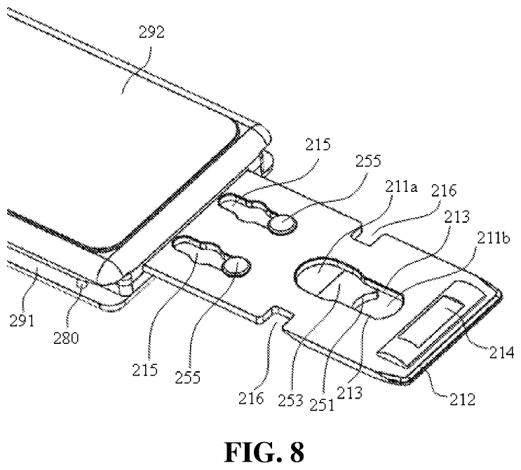

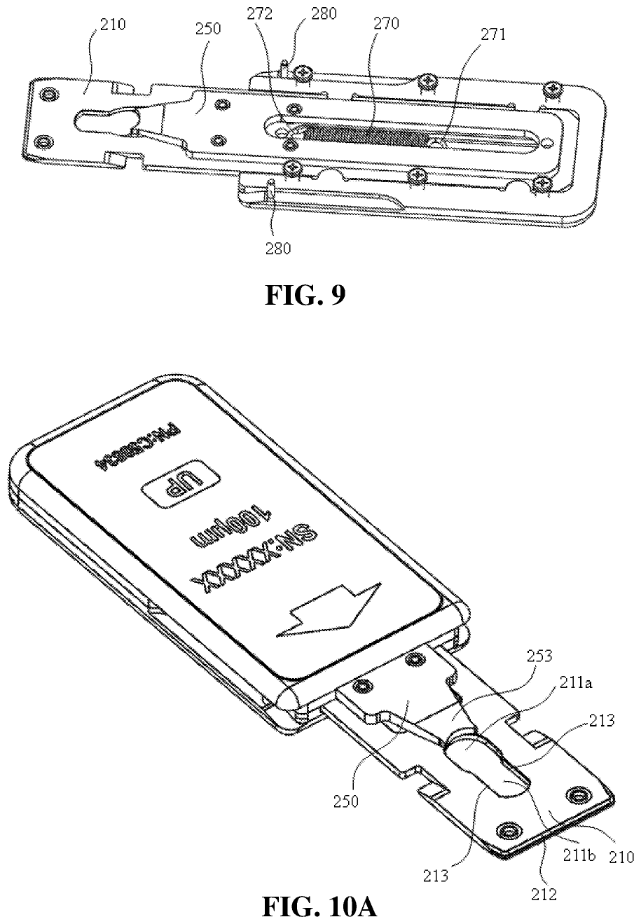

FIG. 5 is a perspective schematic top view of carrier 200 according to an embodiment of the present disclosure. FIG. 6 is a schematic view of carrier 200 of FIG. 5 viewed from another direction. FIG. 7 is a perspective schematic bottom view of carrier 200 according to an embodiment of the present disclosure. FIG. 8 is a schematic view of carrier 200 of FIG. 7 viewed from another direction. FIG. 9 is a schematic view of carrier 200 from which upper cover 291 is removed according to an embodiment of the present disclosure. Carrier 200 will be described in detail below with reference to FIGS. 5 to 9.

Referring to FIGS. 5 to 9, carrier 200 includes base 210. Base 210 is generally plate-shaped. For example, base 210 is in the form of a rectangular plate. Base 210 has insertion end (free end) 212 and substantially parallel side edges 219 extending from insertion end 212. When carrier 200 is inserted, insertion end 212 first enters sample processor 10. Side edges 219 may be shaped to guide the insertion of carrier 200, e.g., to guide the insertion of carrier 200 along frame 500.

Base 210 is provided with an accommodating portion for accommodating nozzle 100. In the example shown in the figure, the accommodating portion includes elongated through hole 211. Elongated through hole 211 includes large-sized portion 211a and small-sized portion 211b. Large-sized portion 211a has a size slightly larger than outer peripheral surface 131 of nozzle 100 so as to load nozzle 100. Small-sized portion 211b has a size smaller than at least a part of outer peripheral surface 131 of nozzle 100 so as to hold nozzle 100 on carrier 200.

Large-sized portion 211a has a shape matching outer peripheral surface 131 of nozzle 100, e.g., a circular arc shape. Small-sized portion 211b has substantially parallel opposite edges 213. Recesses 133 of nozzle 100 respectively receive edges 213, thereby holding nozzle 100 on carrier 200.

Carrier 200 further includes sliding member 250. Sliding member 250 has a similar shape to base 210, but has a smaller size than base 210, thereby not interfering with the insertion of carrier 200. Sliding member 250 can slide relative to base 210. Elongated guide slots 215 are provided in base 210. Sliding member 250 is coupled to base 250 via pins 255 inserted into guide slots 215. Pins 255 can move in guide slots 215 so that sliding member 250 slides relative to base 210.

End surface 251 of sliding member 250 has a shape matching outer peripheral surface 131 of nozzle 100, e.g., a circular arc shape. End surface 251 of sliding member 250 abuts against outer peripheral surface 131 of nozzle 100. End surface 251 of sliding member 250 may have a curvature slightly smaller than that of outer peripheral surface 131, that is, may be in line contact with outer peripheral surface 131.

Sliding member 250 may have tapered end 253. End 253 tapers from side edges of sliding member 250 toward end surface 251. Side edges 252 and 254 of end 253 are not parallel, but are generally V-shaped. V-shaped end 253 may be engaged with a V-shaped slot of positioning member 300 of sample processor 10 when carrier 200 is inserted, which will be described in detail later.

Carrier 200 may further include upper cover 291 and lower cover 292. Upper cover 291 and lower cover 292 constitute the cover of the present disclosure. Upper cover 291 and lower cover 292 may be made in any known manner, e.g., molding. The cover is beneficial for an operator to grasp, protect other parts of the carrier during transportation, and also provide the operator with some information, such as an insertion direction.

Upper cover 291 and lower cover 292 may be connected together in any known manner, e.g., by screws or hinges. Base 210 and sliding member 250 may be partially accommodated in the cover, while an insertion part is exposed outside the cover. In an example not shown, base 210 and sliding member 250 may be fully retracted into the cover so as to prevent from being damaged during transportation.

Carrier 200 may further include biasing member 270 (as shown in FIG. 9). Biasing member 270 may be accommodated in the cover. Biasing member 270 is, e.g., a tension spring, and is configured to bias sliding member 250 toward small-sized portion 211b. One end 271 of biasing member 270 may be connected to sliding member 250, and the other end 272 may be connected to base 210 or the cover. When sliding member 250 slides relative to base 250, energy stored in biasing member 270 also changes accordingly. When nozzle 100 is held at small-sized portion 211b, sliding member 250 pushes nozzle 100 toward insertion end 212 under the action of biasing member 270. The type or connection mode of biasing member 270 may be changed according to specific needs, as long as the functions described herein can be realized.

Base 210 may also be provided with protrusion 214 on the lower surface thereof adjacent to insertion end 212. Protrusion 214 is configured to slide on supporting member 400, which will be described in detail later. To facilitate sliding, protrusion 214 may have a shape that is curved along the insertion direction. In the illustrated example, protrusion 214 has a long shape extending in parallel with insertion end 212 and has an arc-shaped cross section along the insertion direction. It should be understood that protrusion 214 may have a small spherical shape and there may be a plurality of protrusions. The structure and number of the protrusions may be changed as needed, and are not necessarily limited to the specific example shown in the figure.

A protrusion height of protrusion 214 may be greater than or equal to the height of a corresponding part (lower part) of nozzle 100 protruding from carrier 200 when the nozzle is loaded into small-sized portion 211b of carrier 200. In this way, lower end surface 134 of nozzle 100 may be protected from wear or interference when carrier 200 is inserted.

Protrusion 214 may be integrally formed with base 210, or may be a member formed separately and connected or fixed to base 210 as shown in the figure. The formation and connection of protrusion 214 may be changed as needed, and are not necessarily limited to the specific example shown in the figure.

Notches 216 may be provided on opposite side edges 219 of base 210. Notches 216 are used to receive projections of positioning member 300 when carrier 200 is inserted in place, which will be described in detail later. Inclined surfaces 218 extending from notches 216 toward insertion end 212 are provided on an upper surface of base 210. Inclined surfaces 218 are adapted to guide the projections of the positioning member to slide into notches 216.

Carrier 200 may further include locked members 280 locking carrier 200 when inserted in place. Locked members 280 are in the form of pins in the illustrated example. Locked members 280 are between upper cover 291 and lower cover 292, adjacent to the insertion part of carrier 200, and adjacent to side edges of upper cover 291 and lower cover 292. Locked members 280 and locking members 580 installed on frame 500 are engaged when carrier 200 is inserted in place to lock carrier 200. When locking members 580 are disengaged from locked members 280, carrier 200 is in an unlocked state and may be taken out of sample processor 10. It should be understood that the structure, position, etc. of locked members 280 may be changed as needed and are not necessarily limited to the specific example shown in the figure.

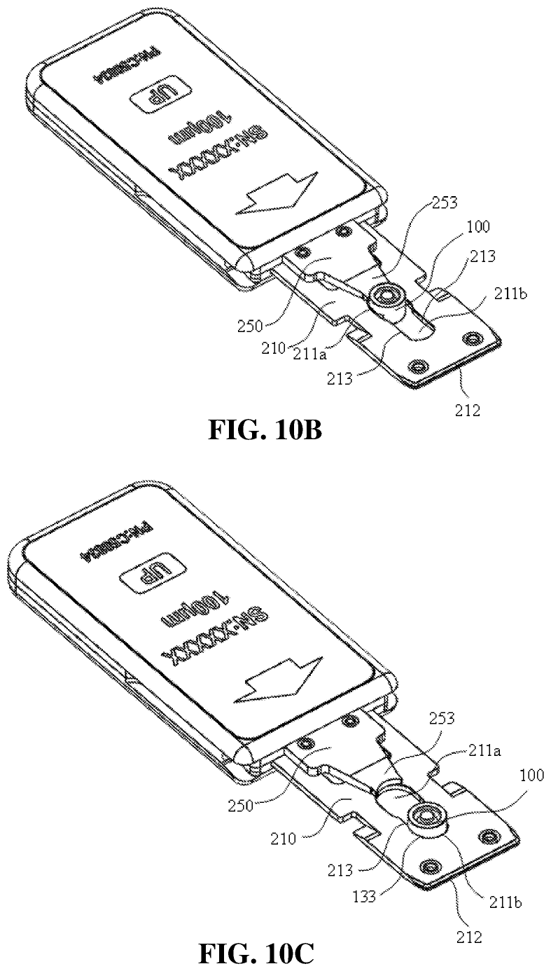

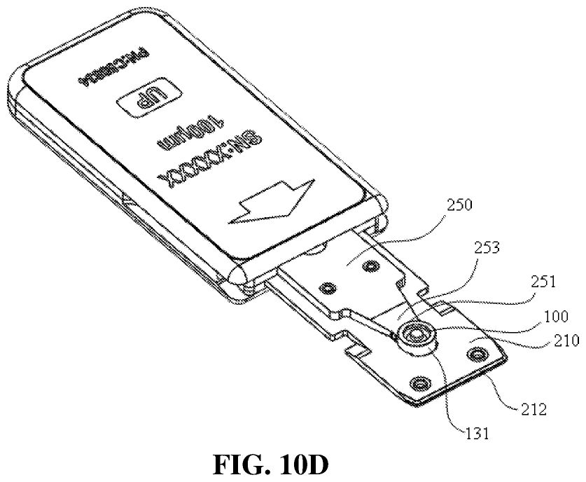

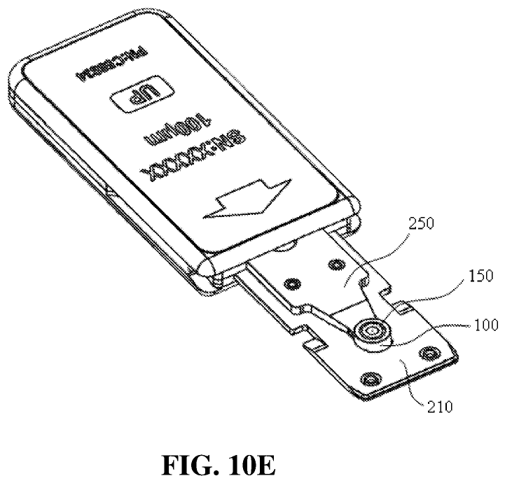

FIGS. 10A to 10E are schematic views showing a process of installing nozzle 100 on carrier 200.

As shown in FIG. 10A, against the action of biasing member 270, sliding member 250 is pushed toward the cover until large-sized portion 211a is exposed to receive nozzle 100. As shown in FIG. 10B, nozzle 100 is placed in large-sized portion 211a. As shown in FIG. 10C, nozzle 100 is pushed into small-sized portion 211b so that recesses 133 of nozzle 100 are engaged with edges 213 of small-sized portion 211b. As shown in FIG. 10D, sliding member 250 is released, and sliding member 250 slides to abut against nozzle 100 under the action of biasing member 270. As shown in FIG. 10E, sealing member 150 is placed in groove 136 of nozzle 100.

It should be understood that the step of placing sealing member 150 may be before loading nozzle 100 on carrier 200. It should be understood that the various steps described herein may be changed without contradiction, and are not limited to the specific example described herein.

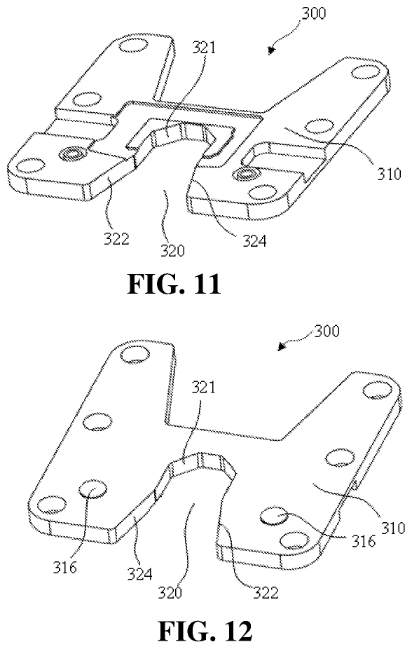

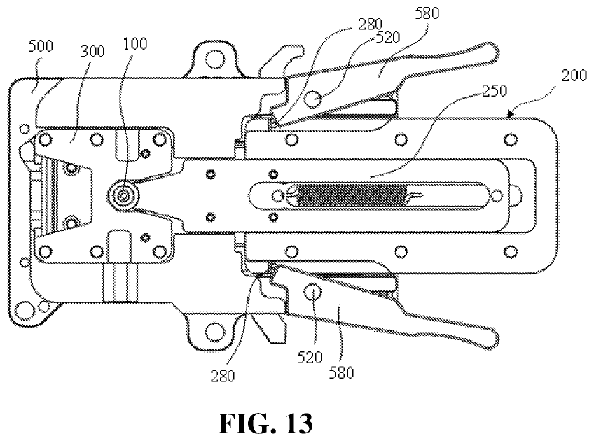

FIG. 11 is a perspective schematic top view of positioning member 300 according to an embodiment of the present disclosure. FIG. 12 is a perspective schematic bottom view of positioning member 300 according to an embodiment of the present disclosure. FIG. 13 is a schematic plan view showing the cooperation of a nozzle assembly with positioning member 300 when inserted in place. Positioning member 300 will be described in detail below with reference to FIGS. 11 to 13.

Positioning member 300 is fixedly installed to frame 500 for positioning nozzle 100. As shown in FIGS. 11 and 12, positioning member 300 includes body 310 that is generally plate-shaped. Body 310 is provided with slot 320 for receiving nozzle 100 when the nozzle assembly is inserted. Slot 320 is generally V-shaped and has non-parallel sides 322 and 324 and bottom 321 between sides 322 and 324. Sides 322 and 324 extend toward bottom 321 in a tapering manner to guide the insertion of nozzle 100 and sliding member 250.

Bottom 321 has a shape matching outer periphery 131 of nozzle 100, e.g., an arc shape. Bottom 321 may have a curvature slightly smaller than that of outer peripheral surface 131, that is, may be in line contact with outer peripheral surface 131. As described above, end surface 251 of sliding member 250 may have a curvature slightly smaller than that of outer peripheral surface 131, that is, may be in line contact with outer peripheral surface 131.

When the nozzle assembly is inserted in place as shown in FIG. 13, nozzle 100 is clamped between bottom 321 of positioning member 300 and end surface 251 of sliding member 250. Since the curvature of outer peripheral surface 131 of nozzle 100 is slightly larger than that of bottom 321 of positioning member 300 and that of end surface 251 of sliding member 250, it is easy to center nozzle 100.

Referring to FIG. 12, projections 316 may be provided on a lower surface of body 310. Projections 316 may be symmetrically provided on both sides of V-shaped slot 320. Projections 316 may have a curved shape, e.g., an arc shape or a spherical shape, so that projections 316 slides onto base 210 of carrier 200. Projections 316 may be integrally formed with body 310 or may be members formed separately and connected or fixed to body 310 as shown in the figure. The formation and connection of projections 316 may be changed as needed, and are not necessarily limited to the specific example shown in the figure.

Projections 316 are configured to slide on the upper surface of base 210 of carrier 200 when the nozzle assembly is inserted to prevent upper surface 132 of nozzle 100 and sealing member 150 from being worn or interfered. When the nozzle assembly is inserted in place, projections 316 may travel into notches 216.

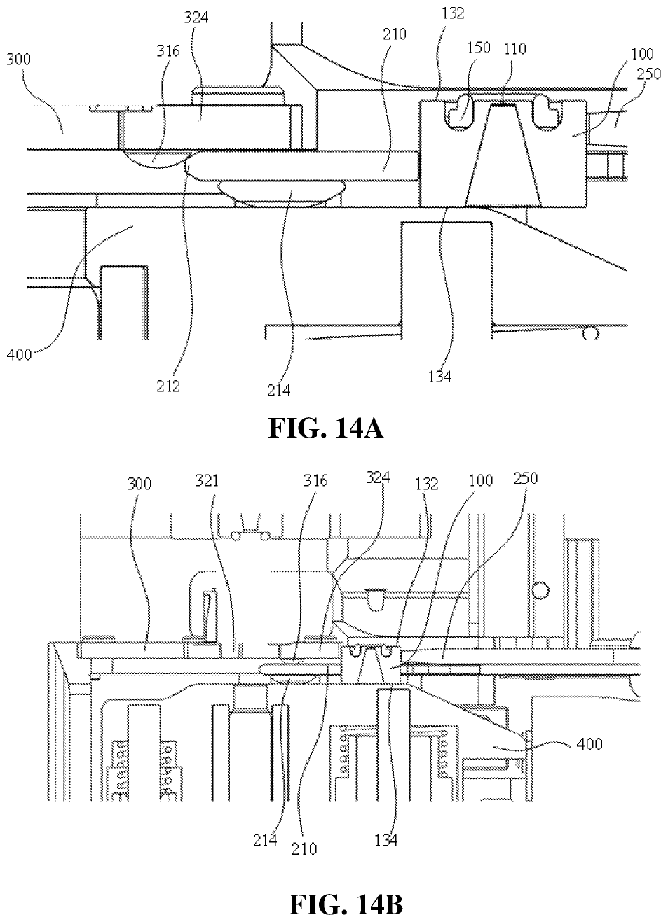

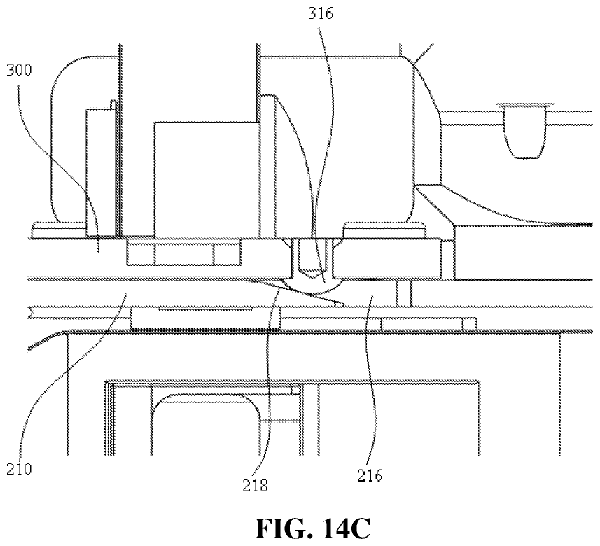

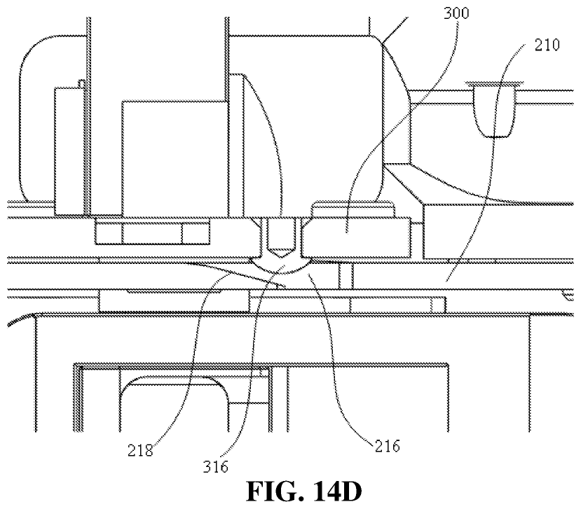

FIGS. 14A to 14D are schematic views showing the mutual cooperation between carrier 200 and projections 316 of positioning member 300 during an insertion process. As shown in FIG. 14A, insertion end 212 of base 210 of carrier 200 travels between positioning member 300 and supporting member 400 and is in contact with projections 316. As carrier 200 is further inserted, projections 316 slide onto the upper surface of base 210 of carrier 200, as shown in FIG. 14B. Preferably, insertion end 212 of base 210 may be rounded. In FIG. 14C, when carrier 200 is about to be inserted in place, projections 316 slide onto inclined surfaces 218 along base 210. When carrier 200 is fully inserted in place, projections 316 are in notches 216 as shown in FIG. 14D.

It should be understood that the structure of positioning member 300 is not necessarily limited to the specific example shown in the figure, but may be changed as needed, as long as the function of positioning the nozzle as described herein can be realized. For example, projections 316 may be provided on the upper surface of base 210 of carrier 200, and notches 216 may be provided on positioning member 300.

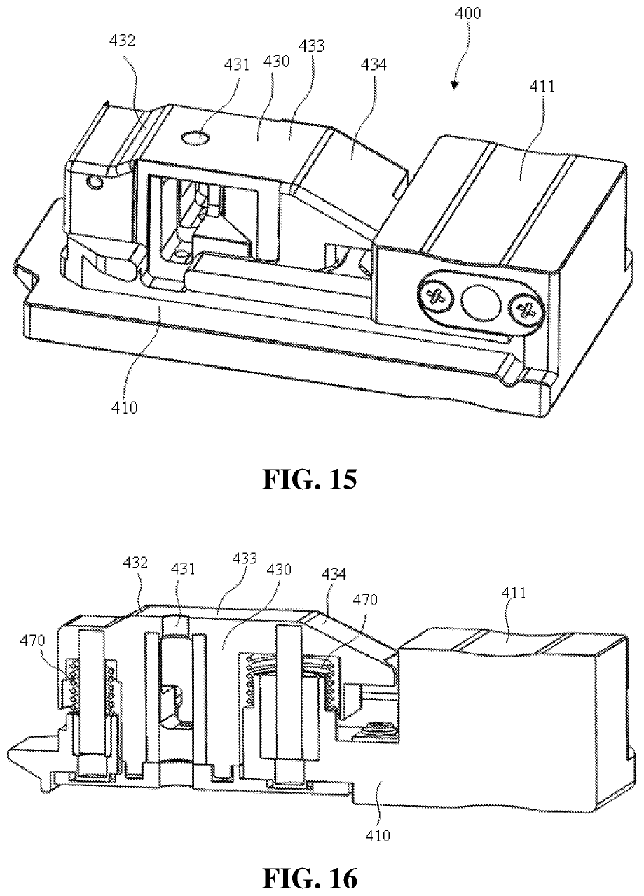

FIG. 15 is a perspective schematic view of supporting member 400 according to an embodiment of the present disclosure. FIG. 16 is a schematic longitudinal sectional view of supporting member 400 of FIG. 15. Supporting member 400 not only can provide carrier 200 with a supporting surface to slide thereon, but also can provide carrier 200 with an upward biasing force so that nozzle 100 firmly abuts against injector body IB. Supporting member 400 will be described in detail below with reference to FIGS. 15 and 16.

As shown in FIGS. 15 and 16, supporting member 400 includes fixed portion 410 fixed to frame 500 and movable portion 430 movable relative to fixed portion 410. Biasing member 470, e.g., a spring, is provided between movable portion 430 and fixed portion 410. Biasing member 470 biases movable portion 430 upward.

Fixed portion 410 has guide surface 411 in first contact with carrier 200 when the nozzle assembly is inserted. Guide surface 411 may extend from the inside of sample processor 10 to the outside. Or, guide surface 411 may be completely outside sample processor 10. Guide surface 411 may be flat or slightly curved, as long as the insertion of carrier 200 is facilitated.

Movable portion 430 is located inside guide surface 411, that is, inside sample processor 10. Movable portion 430 may include middle flat surface 433 for supporting base 210 and downwardly inclined surfaces 432, 434 located on opposite sides of middle flat surface 433 in an insertion direction of base 210. Downwardly inclined surfaces 432, 434 are adapted to guide the sliding of protrusion 214 of base 210.

Through hole 431 is provided in middle flat surface 433 for the passage of the sample injected from nozzle 100. Through hole 431 is positioned to be aligned with nozzle 100 when nozzle 100 is installed in place.

In the illustrated example, two biasing members 470 are arranged on both sides of through hole 431. It should be understood that the structure, arrangement, and number of biasing members 470 may be changed as needed, and are not necessarily limited to the specific example shown in the figure.

In a free state, that is, in a state where the nozzle assembly is not inserted, biasing member 470 may make middle flat surface 433 of movable portion 430 slightly higher than guide surface 411 of fixed portion 410.

When the nozzle assembly is inserted, carrier 200 presses down movable portion 430 against the action of biasing member 470. At this moment, energy is stored in biasing member 470. When the nozzle assembly is inserted in place, biasing member 470 uses the stored energy to apply an upward biasing force to carrier 200 and thus nozzle 100 via movable portion 430, thereby causing nozzle 100 to firmly abut against injector body IB.

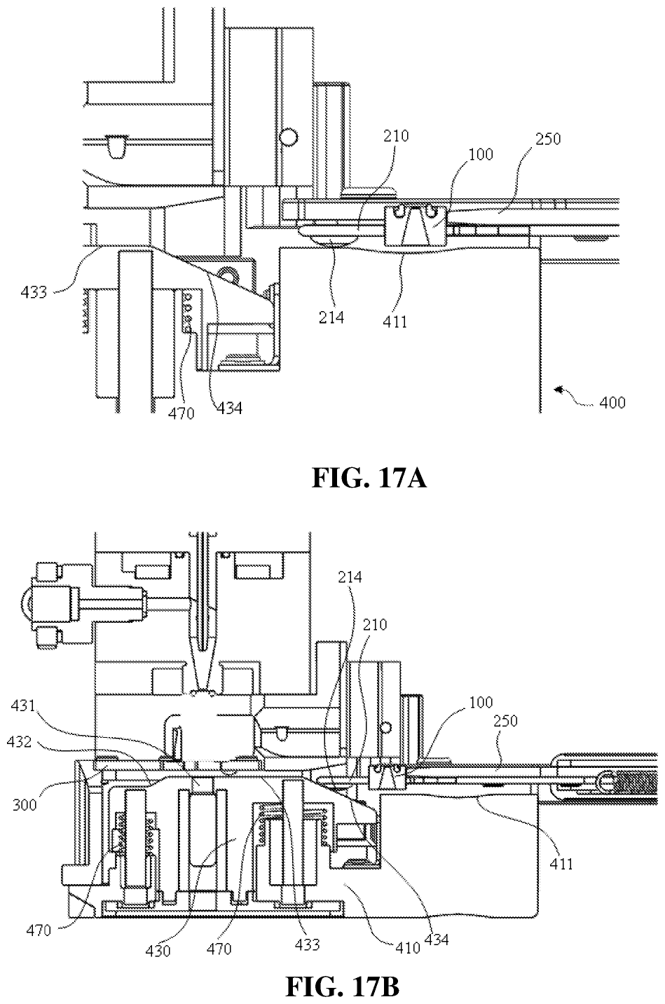

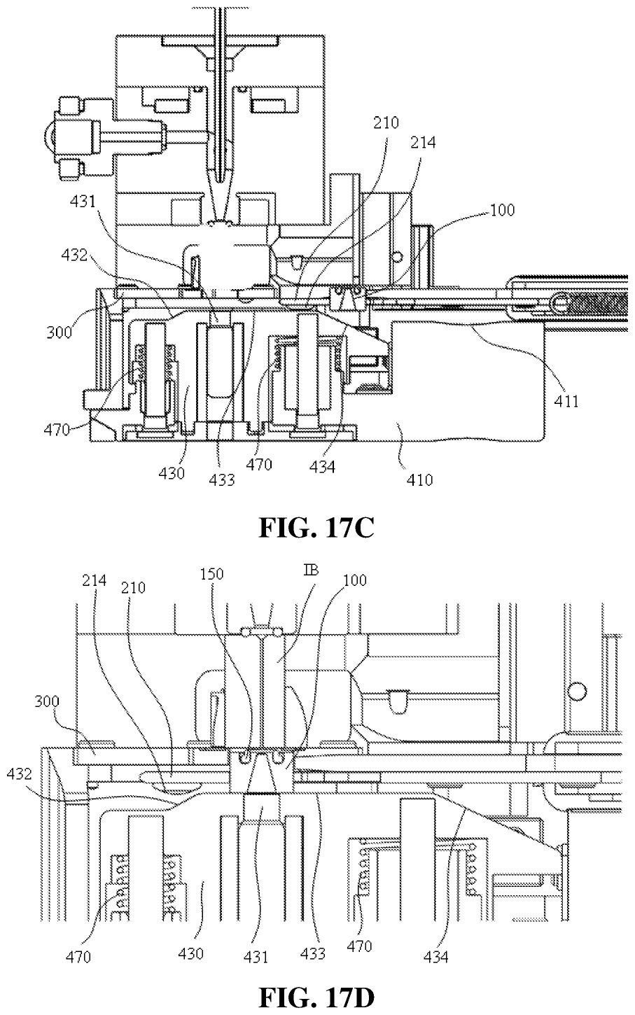

FIGS. 17A to 17D are schematic views showing the mutual cooperation between carrier 200 and supporting member 400 during an insertion process. In FIG. 17A, carrier 200 is placed on guide surface 411 of supporting member 400. Specifically, protrusion 214 of carrier 200 is placed on guide surface 411 and inserted into sample processor 10 under the guidance of guide surface 411. Due to the presence of protrusion 214, lower end surface 134 of nozzle 100 is not in contact with supporting member 400, thereby preventing lower end surface 134 from being worn or interfered. In FIG. 17B, protrusion 214 is in contact with downwardly inclined surface 434 and slides upward under the guidance of downwardly inclined surface 434, while pressing down movable portion 430. In FIG. 17C, protrusion 214 further slides onto middle flat surface 433, and movable portion 430 is in a state of being pressed down at this moment. In FIG. 17D, protrusion 214 has slid over downwardly inclined surface 432. At this moment, under the action of biasing member 470, movable portion 430 moves upward and abuts against the lower end surface of nozzle 100, thereby causing nozzle 100 to tightly abut against the injector body IB via sealing member 150.

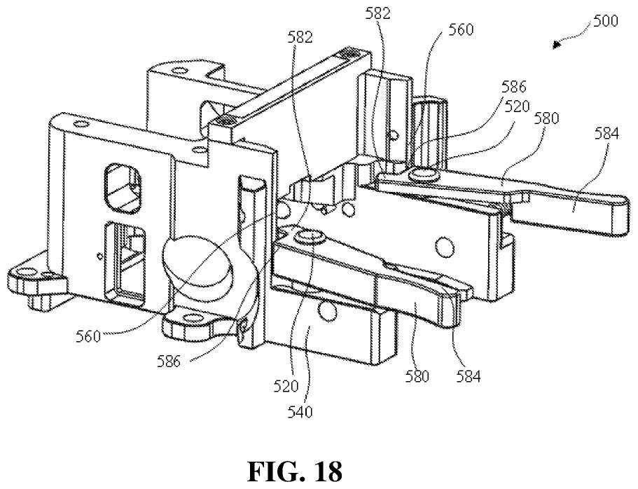

FIG. 18 is a perspective schematic view of frame 500 according to an embodiment of the present disclosure. Frame 500 provides support and installation for various parts of sample processor 10. Therefore, the structure of frame 500 may be changed according to different structures and different arrangements of the various parts of sample processor 10. The parts of frame 500 related to the nozzle assembly of the present disclosure will be described in detail below with reference to FIG. 18.

As shown in FIG. 18, frame 500 includes parallel side walls for accommodating and installing positioning member 300 and supporting member 400. Locking members 580 are rotatably installed to frame 500 via pivots 520. Locking members 580 are configured to be movable between a locking position (as shown in FIG. 13) where the movement of locked members 280 is prevented and an unlocking position (as shown in FIGS. 2A and 2B) where locked members 280 are released.

Locking member 580 includes locking end 582 in cooperation with locked member 280 at the locking position and free end 584 opposite to locking end 582. Locking member 580 further includes stop portion 586. When locking member 580 is at a release position, stop portion 586 is stopped by end 560 of the side wall of frame 500.

Referring to FIG. 13, when the nozzle assembly is inserted in place, locked member 280 moves over locking end 582 of locking member 580, and therefore is stopped by locking end 582 and cannot move outward.

When it is necessary to disassemble the nozzle assembly, free end 584 of locking member 580 is first operated to pivot to the release position. At this moment, the nozzle assembly (carrier 200) may be pulled outward. The process of pulling the nozzle assembly (carrier 200) outward is opposite to the process of inserting the nozzle assembly (carrier 200) described above and will not be described in detail here.

Although the present disclosure has been described with reference to example embodiments, it should be understood that the present disclosure is not limited to the specific embodiments described and illustrated herein. Without departing from the scope defined by the claims, those skilled in the art can make various changes to the example embodiments. Provided that there is no contradiction, the features in the various embodiments may be combined with each other. Or, a certain feature in the embodiments may also be omitted.

1. A nozzle for a sample processor, comprising: a body adapted to be loaded and held in a carrier, wherein the carrier is slidably inserted into the sample processor in a detachable manner; and an orifice provided in an end surface of the body and configured to inject a sample from an injector body in a predetermined mode, wherein the end surface of the body is adapted to abut against an end surface of the injector body along a sample injection direction.

2. The nozzle according to claim 1, wherein the body is configured to be loaded in the carrier in a detachable manner.

3. The nozzle according to claim 2, wherein recesses or tabs engaged with the carrier are provided at opposite positions on an outer peripheral surface of the body.

4. The nozzle according to claim 1, wherein the end surface of the body is provided with a groove for accommodating a sealing member around the orifice.

5. A carrier of a nozzle for a sample processor, comprising: a base provided with an accommodating portion for accommodating the nozzle and configured to be inserted into the sample processor in a detachable manner so that an end surface of the nozzle abuts against an end surface of an injector body along a sample injection direction.

6. The carrier according to claim 5, wherein the accommodating portion comprises an elongated through hole, and the elongated through hole comprises a large-sized portion for loading the nozzle and a small-sized portion for holding the nozzle.

7. The carrier according to claim 6, further comprising: a sliding member capable of sliding relative to the base; and a biasing member biasing the sliding member toward the small-sized portion.

8-9. (canceled)

10. The carrier according to claim 5, further comprising notches provided on opposite side edges of the base, the notches being configured to receive projections of the positioning member when the carrier is inserted in place.

11. The carrier according to claim 10, wherein inclined surfaces extending from the notches toward an insertion end of the base are provided on an upper surface of the base, and the inclined surfaces are adapted to guide the projections of the positioning member to slide into the notches.

12. (canceled)

13. The carrier according to claim 5, further comprising a protrusion provided on a lower surface of the base and adjacent to the insertion end of the base.

14-15. (canceled)

16. A sample processor, comprising: a frame; an injector body configured to receive a sample and a sheath fluid and be fixed to the frame; a nozzle located at the outlet of the injector body and having an orifice for injecting the sample in the injector body in a predetermined mode; and a carrier adapted to load and hold the nozzle and configured to be slidably inserted into the frame in a detachable manner so that an end surface of the nozzle abuts against an end surface of the injector body along a sample injection direction.

17. The sample processor according to claim 16, wherein the nozzle is detachably loaded in the carrier.

18. The sample processor according to claim 17, wherein the carrier comprises a base having an insertion end, the base is provided with an elongated through hole, and the elongated through hole comprises a large-sized portion for loading the nozzle and a small-sized portion for holding the nozzle.

19. The sample processor according to claim 18, wherein recesses engaged with opposite edges of the small-sized portion of the carrier are provided at opposite positions of an outer peripheral surface of the nozzle.

20. The sample processor according to claim 18, wherein the carrier further comprises: a sliding member capable of sliding relative to the base; and a biasing member biasing the sliding member toward the small-sized portion.

21. The sample processor according to claim 20, wherein an end surface of the sliding member has a shape matching an outer peripheral surface of the nozzle.

22. The sample processor according to claim 21, wherein the sample processor further comprises a positioning member for positioning the nozzle, the positioning member is fixed to the frame and has a V-shaped slot, the bottom of the V-shaped slot has a shape matching the outer peripheral surface of the nozzle, and the sliding member has an end that tapers toward the end surface thereof to be engaged with the V-shaped slot of the positioning member.

23-26. (canceled)

27. The sample processor according to claim 18, further comprising a supporting member for supporting the base.

28. The sample processor according to claim 27, wherein the supporting member comprises a fixed portion fixed to the frame and a movable portion movable relative to the fixed portion, the base is supported by the movable portion when inserted in place, a biasing member is provided between the fixed portion and the movable portion, and the biasing member biases the movable portion toward the nozzle.

29-30. (canceled)

31. The sample processor according to claim 16, wherein the orifice is provided in one end surface of the nozzle along an axial direction, and the end surface is provided with a groove for accommodating a sealing member around the orifice.

32-33. (canceled)
